(19) United States
(12) Patent Application Publication
(10) Pub. No.: US 2008/0259477 A1
(43) Pub. Date: Oct. 23, 2008

(54) Rear vision activity mirror

(76) Inventors: Janice Gorton, Brisbane, CA (US); Benson Lam, Hong Kong (CN)

Correspondence Address: Janice Gorton, 91 Paul Avenue, Brisbane, CA, 94005, US

(21) Appl. No.: 11/787,944

(22) Filed: Apr. 18, 2007

(51) Int. Cl. G02B 7/182

(52) U.S. Cl. 359/879; 359/871

(57) ABSTRACT

The described invention embodies the design of a rear vision activity mirror for use in several recreational and sports activities. The rear view mirror is designed to attach to a glove, armband, helmet, wristband, goggles or a Velcro strip that can be connected to several apparatuses, sports equipment and/or activity gear or gear parts. This invention allows the user to acquire rear view vision through a rear view mirror and the design of this invention's swivel mechanism. This device enables the user to see behind in stern view, through a range of rear view angles and perspectives. The position of the rear view mirror can be adjusted to many positions through its ability to swivel and its ability to stay in a “set” position.

### FIELD OF THE INVENTION

The present invention relates generally to mirrors. More particularly, this invention relates to a device that provides for rearward vision when worn by an individual engaged in sporting, recreational, or work-related activities.

### BACKGROUND OF THE INVENTION

The ability of a person to engage in various kinds of working, recreational, and sporting activities may be enhanced by their ability to see visual fields beyond the normal fields they can see with the unaided eye. The rear view mirror of an automobile is a non-limiting example of a device that provides a driver of a vehicle with an additional visual field. A rear view mirror provides a rearward view that would typically require the driver to turn his head or body around, were it not for the mirror, which requires only an upward glance, with minimal bodily movement. The safety of driving is thus greatly improved, and the use of a rear view mirror quickly becomes second nature to most drivers. Mirrors are used in similar ways under other circumstances as well. For example, without limitation, a strategically placed mirror at a blind intersection can provide drivers or pedestrians a view that increases the safety of driveways, or passageways into buildings.

Mirrors have also been adapted for use by bicycles and motorcycles. In general, the mirror is mounted to an appropriate location on the two-wheeled vehicle. However, it may be beneficial in some circumstances to mount the mirror in a location independent of the vehicle in use, or, in some circumstances the person in need of the mirror may not be using a vehicle on which a mirror can be mounted or may not be using a vehicle at all. It is also known to mount a mirror onto a helmet, a mounting location that is independent of the vehicle; however this mounting position is relatively fixed in relation to the position of the user's head. The ability of people to conduct a wide variety of other types of activity may be enhanced in terms of safety, efficacy, or competitive advantage if the people are provided a rearward view. In general these are high intensity activities which require a high degree of attention or concentration, and do not easily allow the person performing the activity to freely turn around, or gaze left and right. Thus, in addition to sporting and recreational activities, such as, but not limited to, bicycling, skiing, snow mobiling, snow boarding, hiking, rock climbing, motorcycling, a number of working situations could be enhanced as well. Such activities include, without limitation, construction work, operation of heavy or potentially dangerous devices and machinery, working in tight spaces, and military and combat activities.

As desirable as a rear view mirror may be in any number of types of activities, the use of a mirror is often prohibited or highly restrictive because of the lack of an appropriate place to mount the mirror. Accordingly, for many recreational, sporting, or work-related activities, a solution to the problem of how or where to mount a mirror is highly desirable.

In view of the foregoing, there is a need for a device that provides a location for mounting a mirror that provides a rearward view that may be used in many various activities such as, but not limited to, recreational, sporting, or work-related activities.

### BRIEF SUMMARY OF INVENTION

The invention generally relates to the provision of a rear view mirror unit for recreational, sporting, and work-related activities that is attached to a bodily-worn article, such as a glove or arm-piece, or otherwise secured to a hand-mounted or arm-mounted base. The mirror is securely attached by a support arm to a base mount. The base mount is attached to a track on the back side of glove's palm. The track allows the mirror to glide across the back of the glove's palm. The attachment of the base mount to the track can be tightened to allow the mirror to be set in any position along the track. The support arm has one or more points of flexibility and rotational swivel that allow the mirror to be positioned at variable angles with respect to the base, and thus with respect to the hand or arm of the user upon which the mirror unit is mounted. These various multiple points of flexibility between the face of the mirror with respect to the physical position of the user permit the user to position the mirror at optimal angles for the activity in which the user is engaged.

In some embodiments of the invention, the mounting base itself is slidably affixed to a track that allows the base to slide into various positions along the track, and with respect to the glove or arm piece on which the track is positioned. In one embodiment of the track, itself, the track comprises two integrated portions, a bed portion, attached directly to an article of clothing, and a raised rail portion, to which the mounting base of the mirror unit is slidably affixed and which can be tighten by a round top screw. The track generally conforms in a planar aspect to the surface area of the article of clothing to which it is attached, and in its lateral aspect may be straight or curvilinear. Mechanisms that slidably affix the base of the mirror to a track include such configurations as a ball and socket mechanism, wherein a ball attached to or integral with the base of the mirror is adapted to fit within a track partially encircling the ball, with longitudinal freedom along the length of the track. Another exemplary configuration is one in which a ring attached to or integral with the base of the mirror partially encircles a longitudinal track, and the overall configuration is similar to that of a monorail car on a monorail. At the base of the mirror is a small rod with a round ball end. This is held in place by two clamps that can be tighten by a small wing nut.

The mirror is small, lightweight, and compact, and embodiments contain various degrees of curvature or convexity in order to provide the user with an optimal viewing range. The mirror may further include a collapsible feature such that it may be positioned in alignment against the glove or arm when not in use and held in place by a small piece of velcom Embodiments of the mirror include both left hand and right hand versions. A user of the inventive mirror unit may make use of either the left-hand embodiment, the right-hand embodiment, or both simultaneously. The glove or arm-piece to which the mirror is attached may be fabricated from a wide variety of materials, including fabric, leather, plastic, and metal, in accordance with the uses, working environment, or the weather and temperature conditions within which the mirror is being utilized. In some embodiments, the glove has additional features such as padding, or water repellent covering. The worn article upon which the mirror is mounted may be further enhanced by the inclusion of a range of safety and utilitarian features such as a small pocket to hold keys or electronic keys, or any of a range of small items or devices, as for example a small compass. Still further, reflector tape and/or reflector plastic may be included on the surface or integrated into the glove.

It is thus an object of the invention to provide a rear vision activity mirror for use in human activities, such activities being classified broadly, for example, as work-related, recreational in nature, or of a sporting nature. Work-related activities may include, for example, construction work such as steel work or carpentry, operating heavy machinery, military or law enforcement work. Recreational activities may include casual biking, boating, hiking, rock climbing, and the like. Athletic or sporting events may be similar to recreational activities, but generally are more strenuous, intense, and competitive, such as bicycle road racing. Clearly, a wide variety of activities may be able to utilize the inventive rear view activity mirror, the aforementioned examples are not limiting, but merely suggestive of common uses. As mentioned in the background, what these activities have in common is the requirement for a high level of forward-directed concentration, physical constraints and time constraints that preclude an easy turning of the head, and a high level of interest on the part of the wearer of the inventive device in knowing what is going on behind him or her.

It is further an object of the invention to provide a mirror with a support arm, which on its distal end is attached to the mirror, and on its proximal end, attached to a base. The attachment of the support arm, in a preferred embodiment, includes a ball that is held is place by two clamps tighten by a small wing nut is integral with the proximal end of the support arm, and the ball is integral with the portion of a mounting mechanism associated with the base.

It is further an object of the invention to provide a bodily-attached or bodily-worn article to which the base is attached. Such articles may include, for example, an arm band, a wrist band, a helmet, a glove, a shirt or jacket-like article which engages the human torso and includes sleeves that may extend the length of the arm. Preferred embodiments include articles worn on the arm, the arm being defined in the broadest terms so as to include the complete limb, from the shoulder and extending to include the wrist, hand, and fingers. The straps or bands may be reversibly opened and closed, by such mechanisms well known in the art, such as buckles, clasps, or Velcro attachments. Such worn articles may include both gloves and shirt-like articles of clothing. The invention further provides that embodiments may be designed to serve both the right and left side of the body, but other embodiments may be designed to be appropriately used on either the left side or right side of the body.

It is still further an object of the invention to provide a rear view, bodily attached mirror that has various elements of flexion and swivel, with respect to the proximal, bodily-attached portion of the mirror, and the distal end of the activity mirror, where the mirror is attached to the support arm. There may be one or more points of rotational swivel, such swivel mechanism may be included within the joint mechanism where the support arm is joined to the base, or at the point of attachment between the support arm and the mirror, or at any point between the proximal and distal ends of the support arm. Similarly, a point of flexion may be located at either the proximal or distal end of the support arm, or at any point in between. These various points of flexion provide for adjustment of the planar surface of the mirror with respect the mirror base or the body, as well as with respect to the line of sight from the eye of the wearer of the activity mirror. These points of swivel and flexion are configured with an appropriate amount of tension, one that allows readily manual adjustment, but that hold their position stably when in use. In an exemplary embodiment, the points of flexion, or a combination of swivel and flexion allow for the mirror on its support arm to be collapsed against the body or base, such that when the mirror is not in use, and is out of the way, the mirror creates a minimal profile against the base. Such an option is useful when the wearer does not want to remove the activity mirror, but wants it to be not in use, or out of the way for whatever reason, for a period of time.

In one embodiment a variation of a ball and socket joint provides for an extended track in which the ball slides, creating a ball-in-a-track type of slidable attachment, with the track clasping the ball. In another embodiment, the base portion of the mirror is adapted to slidably grasp the track. The track may range in length, according the nature of the worn article, and other variables specific to the wearer or the activity engaged in. A short track length could be, for example, half an inch, or an inch. This short track would be for use in articles of clothing or for uses in which there are practical physical constraints, but where a relatively small difference in position can be important. In other embodiments, where the track is mounted on a glove with an extended cuff, or on the sleeve of a jacket like article of clothing, the track could extend for a distance of several inches up to about a foot. The mechanism by which the basal portion of the mirror is slidably associated with the track is constructed with an appropriate amount of tension, such that the mirror can slide easily with directed manipulation, but is stable in a position when left alone. Further, in some embodiments, the track may contain particular areas where there is a point of stability, wherein the ball snaps into a position at a node and is more stable that it is when on the track between such nodes.

It is also an object of the invention to provide an activity mirror with planar mirror surfaces of different dimension, sizes, shapes, and various degrees of convexity, so as to provide the optimal viewing range for various types of activity, or to adjust for other specifics that may include such variables as the size of the wearer, the immediate working environment, frequency of use, and personal preferences.

### BRIEF DESCRIPTION OF DRAWINGS

The present invention is best illustrated by way of example, and not by way of limitation, in the figures of the accompanying drawings and in which like reference numerals refer to similar elements and in which:

FIGS. 1A, 1B, and 1C illustrate an exemplary rear vision activity mirror, in accordance with an embodiment of the present invention. FIG. 1A is a perspective view of the exemplary rear vision activity mirror unit attached to a glove. FIG. 1B is a front view of the rear vision activity mirror, and FIG. 1C is a side view of a connecting bracket of the rear vision activity mirror;

FIG. 2 illustrates an exemplary ball-mounting base in an exemplary track for a rear view activity mirror unit, in accordance with an embodiment of the present invention;

FIG. 3 illustrates an exemplary rear view activity mirror unit 301 mounted on an armband 306, in accordance with an embodiment of the present invention; and

FIG. 4 illustrates an exemplary rear view activity mirror unit 401 mounted on a ski pole 409, in accordance with an embodiment of the present invention.

Unless otherwise indicated, illustrations in the drawings are not necessarily drawn to scale.

### DETAILED DESCRIPTION OF THE INVENTION

The present invention is best understood by reference to the detailed figures and the description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, without limitation, it should be appreciated that those skilled in the art will, in light of the teachings of the present invention, recognize a multiplicity of alternate and suitable approaches, depending on the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Embodiments of the present invention provide rear view mirror units for recreational, sporting, and work-related activities that may be attached to a bodily-worn article, such as, but not limited to, a glove or armband, or otherwise secured to a hand-mounted or arm-mounted base. The mirror in these embodiments is securely attached by a support arm to a base mount. In some embodiments, the base mount is attached to a track on a backside of a glove's palm. In these embodiments, the track enables the mirror to glide across the back of the glove's palm and be adjusted to the user's preference. The attachment of the base mount to the track can be tightened to enable the mirror to be set in any position along the track. In the preferred embodiment, the support arm has one or more points of flexibility and rotational swivel that enable the mirror to be positioned at variable angles with respect to the base, and thus with respect to the hand or arm of the user upon which the mirror unit is mounted. These various multiple points of flexibility between the face of the mirror with respect to the physical position of the user permit the user to position the mirror at optimal angles for the activity in which the user is engaged.

Some embodiments of the present invention provide a bodily-attached or bodily-worn article to which a mirror is attached. Such articles may include, for example without limitation, a strap, an armband, a wristband, a helmet, a glove, a shirt or jacket-like article which engages the human torso and includes sleeves that may extend the length of the arm. Preferred embodiments include, without limitation, articles worn on the arm, the arm being defined in the broadest terms so as to include the complete limb, from the shoulder and extending to include the wrist, hand, and fingers. Straps or bands used in some embodiments may be reversibly opened and closed, by such mechanisms well known in the art, such as, but not limited to, buckles, clasps, or Velcro™ attachments. Bodily-worn articles into which a mirror may be attached may include, without limitation, gloves and shirt-like articles of clothing. The article to which the mirror is attached, for example without limitation, a glove or armband, may be fabricated from a wide variety of materials, including, without limitation, fabric, leather, plastic, and metal, in accordance with the uses, working environment, or the weather and temperature conditions within which the mirror is being utilized. Other embodiments provide a mirror that may be attached to equipment other than the body of the user, for example, without limitation, ski poles.

Embodiments of the present invention provide a rear vision activity mirror for use in various activities, such activities being classified broadly, for example without limitation, as work-related, recreational in nature, or of a sporting nature. Work-related activities may include, for example without limitation, construction work such as, but not limited to, steel work or carpentry, operating heavy machinery, military or law enforcement work. Recreational activities may include, without limitation, casual biking, boating, hiking, rock climbing, and the like. Athletic or sporting events may be similar to recreational activities, however generally are more strenuous, intense, and competitive, such as, but not limited to, bicycle road racing. A wide variety of activities may be able to utilize embodiments of a rear view activity mirror; the aforementioned examples are not limiting, but merely suggestive of common uses. As mentioned in the background, what these activities have in common is the requirement for a high level of forward-directed concentration, physical constraints and time constraints that preclude an easy turning of the head, and a high level of interest on the part of the wearer of the inventive device in knowing what is going on behind him or her.

Embodiments of a rear view activity mirror include both left hand and right hand versions. A user of a rear view activity mirror unit may make use of a left-hand embodiment, a right-hand embodiment, or both simultaneously. Some embodiments may be designed in such a way that the same embodiment may be used as both a right hand and a left hand version. For example, without limitation, the support arm of the mirror may attach to the center of the mirror instead of to one side so that the mirror may be used on either side of the user.

One non-limiting example of a situation in which a rear view activity mirror according to embodiments of the present invention may be used involves a bicyclist who wants to ride his bike through a congested city street with considerable traffic, buildings, and street intersections. Navigating a bicycle through this area involves dealing with a considerable number of safety issues. The bicyclists must be able to navigate forward while avoiding rear moving objects such as, but not limited to, other bicyclists, cars, or pedestrians which are moving in his stern. To help the bicyclist navigate safely, using the rear view activity mirror attached to a sports glove will provide the bicyclist with “dual view” vision. The bicyclist can easily glance down to see objects behind him in the rear view activity mirror while still being able to see forward. The rear view activity mirror can help the bicyclist navigate his way through busy streets in a safer manner, by letting him steer his way forward knowing what is approaching him from the rear.

Another non-limiting example of an embodiment of a rear view activity mirror in use involves a novice skier skiing down a ski slope that is crowded with many skiers. Looking behind is challenging while on skis as turning the body around or turning the neck to see behind can cause balance problems and may cause the skier to fall. As there are more advanced skiers on the slope skiing downhill in the present example, the skier is concerned that if he turns right or left he may collide with a skier who is uphill and skiing downhill behind his back. By wearing a rear view activity mirror on an armband or having a rear view activity mirror strapped to his ski pole, the skier can easily gain rear view vision and make the correct movements and turns by seeing what is behind him.

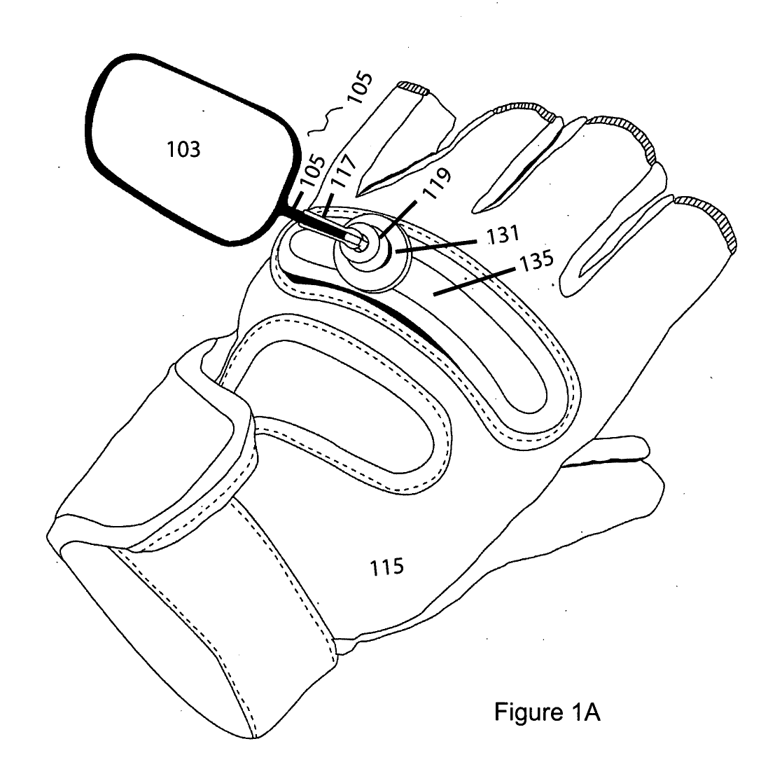

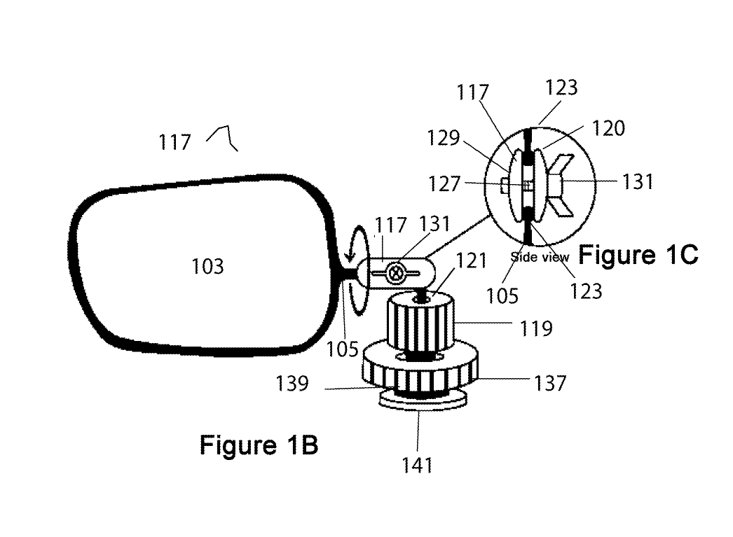

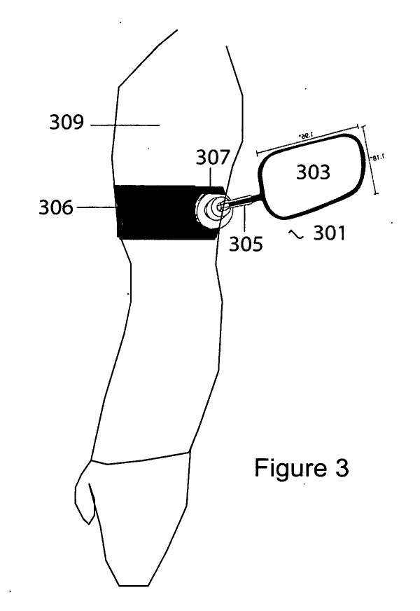

FIGS. 1A, 1B, and IC illustrate an exemplary rear vision activity mirror 101, in accordance with an embodiment of the present invention. FIG. 1A is a perspective view of exemplary rear vision activity mirror unit 101 attached to a glove 115. FIG. 1B is a front view of rear vision activity mirror 101, and FIG. 1C is a side view of a connecting bracket 117 of rear vision activity mirror 101. In the present embodiment, rear vision activity mirror unit 101 comprises a mirror 103 that is attached to a support arm 105 that is, in turn, attached or mounted to a base 107, which is attached or integrated into a worn article. In the present embodiment, the worn article is glove 115. In the present embodiment, mirror 103 is a compact rear view mirror shaped in a convex, wedged-shaped design. Mirror 103 is small, lightweight, and compact. Various embodiments contain various degrees of curvature or convexity of the mirror in order to provide the user with an optimal viewing range. The preferred embodiment includes a small convex-shaped rear view mirror that can have several sizes and angles depending on the recreation and/or sports application and the article of clothing or equipment to which the base of the mirror is attached. For example, without limitation, a rear view mirror fitting an armband may be larger than a rear view mirror fitting a bicycle glove or ski pole. Preferred embodiments comprise mirrors with a convex, wedge shape regardless of the size of the mirror. In the present embodiment, the preferred size for rear view mirror 103, because of its location on sports glove 115, is 1 inch to 2¼ inches in length and ¾ inch to 1½ inch in height at the top point of the wedge; however, other sizes may also be suitable. In an exemplary embodiment where the mirror is attached to an armband, as shown by way of example in FIG. 3, the preferred size for the mirror is in the range of 1 inch to 3 inches in length and 1 inch to 1½ inches in height at the top point of the wedge that angles downward. This size may vary in alternate embodiments. These exemplary sizes are dependant on the connecting apparatus. Other factors that may determine the size of the mirror include, without limitation, the size of the user, frequency of use, and user preference. The wedge shape of mirror 103, according to the present embodiment, provides a convex downward angle to provide a wide-angle viewing perspective. In alternate embodiments mirrors may be of various different shapes. For example without limitation, some embodiments may comprise a round, convex mirror, and other embodiments may comprise a rectangular mirror. In the present embodiment, mirror 103 is made of a reflective mirror laminate similar in quality to a car “spot mirror” that also provides wide-angle, rear view vision.

The present embodiment comprises various elements of flexion and swivel, with respect to the proximal, bodily-attached portion of the mirror, and the distal end of the activity mirror, where the mirror is attached to the support arm. These elements of flexion are shown in detail by way of example in FIGS. 1B and 1C. In alternate embodiments there may be one or more points of rotational swivel, such swivel mechanism may be included within the joint mechanism where the support arm is joined to the base, or at the point of attachment between the support arm and the mirror, or at any point between the proximal and distal ends of the support arm. Similarly, a point of flexion may be located at either the proximal or the distal end of the support arm, or at any point in between. These various points of flexion provide for adjustment of the planar surface of the mirror with respect the mirror base or the body, as well as with respect to the line of sight from the eye of the wearer of the activity mirror. In preferred embodiments, these points of swivel and flexion are configured with an appropriate amount of tension that enables readily manual adjustment, but that holds the position of the mirror stably when in use.

As shown by way of example in FIG. 1B, in the present embodiment, mirror 103 is attached to a 360-degree rotating and “back and forth” swiveling connecting bracket 117. Connecting bracket 117 is affixed to a 360-degree swivel base 119. In the present embodiment, swivel base 119 is designed as a mound of hollow rubber with an open cavity and circle opening. In alternate embodiments swivel base 119 may be made of materials other than rubber such as, but not limited to, various plastics, and may be many different shapes. An end ball of a connecting rod 121 fits snuggly into swivel base 119 so that connecting rod 121 is able to rotate 360-degrees. This enables the entirety of rear vision activity mirror unit 101 to rotate in a 360-degree manner, as well as enabling only mirror 103 to rotate in a 360-degree manner. Swivel base 119 may be attached to a range of surfaces such as, but not limited to, an armband, wristband, glove, helmet, Velcro™ strap, sports equipment or activity gear or gear parts.

The ability of mirror 103 to swivel and to be set in place is achieved in the present embodiment by using small rods with ball ends that connect to mirror 103 and swivel base 119. One of these rods is support arm 105 and the other is connecting rod 121. These two rods have end balls 123, and end balls 123 are sandwiched in place by two halves of connecting bracket 117. Detail of connecting bracket 117 is shown by way of example in FIG. 1C. Each half of connecting bracket 117 features two concave circles on the interior having the appropriate depth and width to hold end balls 123 in place and enabling end balls 123 to rotate 360-degrees. Pressure is created on end balls 123, which causes mirror 103 to stay in place after mirror 103 is moved into its “set” position. This is achieved through a center-threaded shaft 127 that holds the two halves of connecting bracket 117 together. Pressure is achieved on end balls 123 by tightening threaded shaft 127 with a bottom bolt 129 and nut 131. This brings the halves of connecting bracket 117 together on the top and bottom of end balls 123, putting pressure on end balls 123. The mechanism according to the present embodiment enables a 360-degree and “forward and backward” range of positions to be set by the user without the rear view mirror moving from its “set” position.

Connecting bracket 117 and swivel base 119 enable mirror 103 to fold and lay flat against glove 115. In alternate embodiments similar swiveling and flexing mechanisms enable the mirror to fold and lay flat against the various other attaching surfaces that a mirror may be attached to such as, but not limited to, an armband's top side, the sleeve of a jacket, the side of a helmet, or the side of a ski pole. This enables mirror 103 to create a minimal profile against the attaching surface when not in use. In some embodiments in which the mirror may be positioned in alignment against the attaching surface when not in use, the mirror may be held in place by means such as, but not limited to, a small piece of Velcro™ or an elastic strap. In some embodiments, the mirror can be concealed by a top flap such as, but not limited to, a spandex flap with Velcro™ or a snap sewn into a cover flap.

With 360-degree rotating connecting bracket 117 and swivel base 119 incorporated into the present embodiment, rear vision activity mirror unit 101 provides users a broad rear view radius and varied rear view visual angles. Embodiments of the present invention can also include several utilitarian features such as, but not limited to a small pocket on the attaching surface for holding keys and/or a small compass adhered to attaching surface. In addition, to increase safety attributes, some embodiments can incorporate reflector tape or reflector plastic on the attaching surface or other materials. This provides added safety attributes, particularly in night use. In embodiments comprising a glove as the attaching surface, the glove may have additional features such as, but not limited to, padding or a water repellant covering.

The attachment method and materials used to adhere the mounting base to its attaching surface is dependant on the type of surface being used to join the connection, for example without limitation, an armband, wristband, glove, helmet, sports equipment, activity gear or gear parts, or a Velcro™ strap. In various embodiments, the mounting base can be attached to its attaching surface, through various means such as, but not limited to, glue, sewing, Velcro™, clamps, rivets, welding or other affixing substances or techniques. In the present embodiment, swivel base 119 of rear view activity mirror unit 101 is slidably affixed to a track 135 that enables swivel base 119 to slide into various positions along the track, and with respect to glove 115 on which track 135 is positioned. Swivel base 119 is coupled to track 135 with a flat rectangular plate 141 that fits into grooves on both sides of track 135. Plate 141 along with swivel base 119 and the entire rear view activity mirror unit 101 slides back and forth in the grooves of track 135. Track 135 generally conforms in a planar aspect to the surface area of glove 115, and in its lateral aspect, track 135 may be straight or curvilinear. Track 135 is preferably made of plastic; however, various other materials may be suitable for track 135 including, without limitation, heavy fabrics, composite materials, or metal. In the present embodiment, swivel base 119 comprises an integrated track-clasping ring 137, which secures swivel base 119 to track 135. When swivel base 119 is in the desired position on track 135, track-clasping ring 137 is tightened onto track 135 by screwing track-clasping ring 137 down a threaded rod 139, thus squeezing part of track 135 between track-clasping ring 137 and plate 141. In alternate embodiments plate 141 may be a different shape such as, but not limited to a square or a disk.

In typical use of the present embodiment, the user puts on glove 115 and slides rear view activity mirror unit 101 into the desired position along track 135 and tightens track-clasping ring 137 to hold rear view activity mirror unit 101 in place. The user may then swivel and bend mirror 103 into a suitable position and angle for the activity being performed using the elements of flexion and swivel created by swivel base 119 and connecting bracket 117.

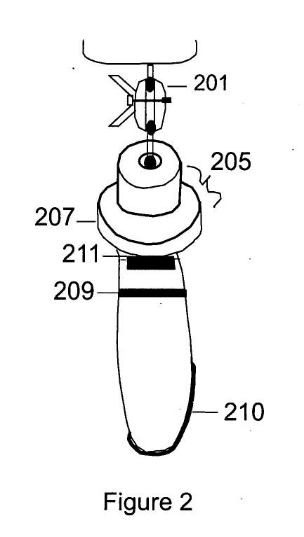

Those skilled in the art, in light of the present teachings, will recognize that there are various different means for implementing a mirror in a track. The following are some non-limiting examples. In one embodiment at the base of the mirror is a small rod with a round ball end. This rod is held in place by two clamps that can be tightened by a small wing nut. In another embodiment of a track, the track comprises two integrated portions, a bed portion, attached directly to an article of clothing, and a raised rail portion, to which the mounting base of the mirror unit is slidably affixed and which can be tighten by a round top screw. Other mechanisms that slidably affix the base of the mirror to a track include, without limitation, a ball and socket mechanism, wherein a ball attached to or integral with the base of the mirror is adapted to fit within a track partially encircling the ball, with longitudinal freedom along the length of the track, as shown by way of example in FIG. 2. Another exemplary embodiment is one in which a ring attached to or integral with the base of the mirror partially encircles a longitudinal track. The overall configuration of this embodiment is similar to that of a monorail car on a monorail. In another embodiment, the base portion of the mirror is adapted to slidably grasp the track. Many of the track embodiments described may also include points along the track where the base of the mirror may “snap” or “lock” into place to provide added stability for the rear view activity mirror unit. For example, without limitation, in the embodiment shown by way of example in FIG. 1, track 135 may include incremental notches into which nubs that may be included on plate 141 fit, limiting the side-to-side movement of the base of rear view activity mirror unit 101. In other embodiments the rear view activity mirror unit may not be slidably attached to a track on the attaching surface. Instead in these embodiments, the rear view activity mirror unit may be attached in a stationary manner, for example, without limitation, glued to the attaching surface, or may be attached only in a swiveling manner. For example, without limitation, a mirror may be attached to an attaching surface with a ball and socket joint so that the socket is fixed to the attaching surface and the ball is on the end of the mirror so that the mirror can swivel into different positions with respect to the attaching surface. In yet another embodiment, the support arm of the rear view activity mirror unit may be fixed to the attaching surface, and there may be a ball and socket joint between the end of the support arm and the mirror.

FIG. 2 illustrates an exemplary ball-mounting base 205 in an exemplary track 210 for a rear view activity mirror unit 201, in accordance with an embodiment of the present invention. Ball-mounting base 205 comprises a track-clasping ring 207 and a ball 209. In the present embodiment a variation of a ball and socket joint provides for an extended track 210 in which ball 209 slides, creating a ball-in-a-track type of slidable attachment, with track 210 clasping ball 209. When ball-mounting base is in the desired position along track 210, track-clasping ring 207 is screwed down a threaded rod 211 onto track 210 and tightened, squeezing an upper portion of track 210 between track-clasping ring 207 and ball 209. This stabilizes ball-mounting base 205 into place. Track 210 may vary in length, according to the nature of the worn article, and other variables specific to the user or the activity in which the user is engaged. A short track length may be, for example without limitation, half an inch, or an inch. This short track would be useful in articles of clothing or for uses in which there are practical physical constraints, but where a relatively small difference in position can be important, for example, without limitation, a ski pole or a small glove arm band, rock climbing pole. In other embodiments, for example without limitation, where the track is mounted on a glove with an extended cuff, or on the sleeve of a jacket-like article of clothing, the track may extend for a distance of several inches up to about a foot. In the present embodiment, the mechanism by which the base portion of the mirror is slidably associated with the track is constructed with an appropriate amount of tension, such that the mirror can slide easily with directed manipulation, but is stable in a position when left alone. Further, in some embodiments, the track may contain particular areas where there is a point of stability, for example, without limitation, wherein the ball snaps into a position at a node and is more stable that it is when on the track between such nodes. These features of variable track length, tension in the connection, and stability points may also be incorporated into alternate track embodiments including, but not limited to, those previously described.

FIG. 3 illustrates an exemplary rear view activity mirror unit 301 mounted on an armband 306, in accordance with an embodiment of the present invention. In the present embodiment, rear view activity mirror unit 301 comprises a mirror 303, a support arm 305, and a base mount unit 307. Base mount unit 307 may comprise various means for adjusting the position of mirror 303 in respect to support arm 305. These means for adjusting may be similar to swivel base 119 and connecting bracket 117, shown by way of example in FIGS. 1B and 1C, or may be other means for adjusting such as, but not limited to, a ball and socket joint or multiple hinges. In the present embodiment, base mount unit 307 may be attached to armband 306 on a track, as shown by way of example in FIG. 1A, or may be fixed to armband 306 in a stationary manner. If base mount unit 307 is attached to armband 306 on a track, various types of tracks or sliding means may be implemented as previously described. In typical use of the present embodiment, armband 306 may be secured in any useful or comfortable position on an arm 309 of a user. Complimentary buckle units well known in the art are located at either end of armband 306. In alternate embodiments various means for closing armband 306 other than buckles may be used, for example, without limitation, Velcro™ closures, snaps, hooks, etc. A user may have multiple mirror units attached to their arm if desired.

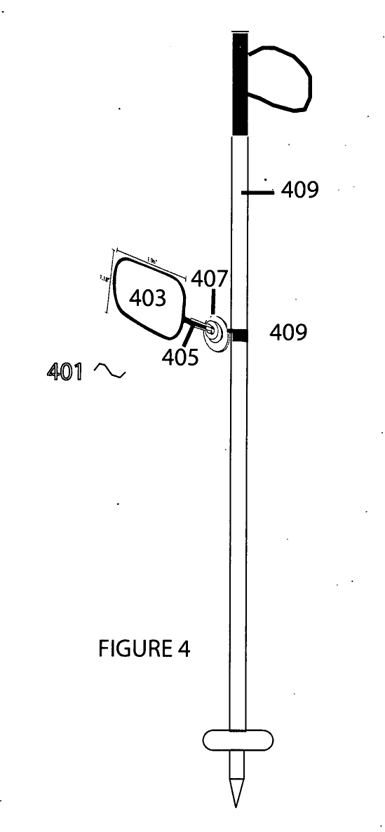

FIG. 4 illustrates an exemplary rear view activity mirror unit 401 mounted on a ski pole 409, in accordance with an embodiment of the present invention. In the present embodiment, rear view activity mirror unit 401 comprises a mirror 403, a support arm 405, and a base mount unit 407. Base mount unit 407 may comprise various means for adjusting the position of mirror 403 in respect to support arm 405. These means for adjusting may be similar to swivel base 119 and connecting bracket 117, shown by way of example in FIGS. 1B and 1C, or may be other means for adjusting such as, but not limited to, a ball and socket joint or multiple hinges. It may be desirable to implement simpler adjusting means in the present embodiment in order to keep the overall size of rear view activity mirror unit 401 small because of the narrow size of ski pole 409. In the present embodiment, base mount unit 407 is mounted to ski pole 409 with a strap 406. Strap 406 may be closed by various means such as, but not limited to, a buckle, Velcro™, snaps, or hooks. Furthermore, strap 406 may be made of various different materials including, without limitation, nylon, elastic, or plastic. In the present embodiment, base mount unit 407 is attached to strap 406 in a stationary manner; however, in alternate embodiments base mount unit 407 may be attached to strap 406 with a short track. In typical use a user secures strap 406 around ski pole 409 at the desired height, and the user positions mirror 403 in the desired position using the adjustment means in base mount unit 407.

Having fully described at least one embodiment of the present invention, other equivalent or alternative means for implementing a rear view activity mirror unit that may be attached to various types of apparel or equipment according to the present invention will be apparent to those skilled in the art. For example, without limitation, the preferred embodiments above are described as being attached an article that is worn on the arm or hand of the user. However, alternate embodiments may be attached to articles that are worn on various other parts of the user's body such as, but not limited to the head, chest, or legs. For example, without limitation, in one embodiment a rear view activity mirror unit is attached to a headband. Some activities, such as, but not limited to, street luge, may require the user to be in a prone position. An embodiment designed for these types of activities may incorporate a rear view activity mirror unit into the chest area of a shirt or jacket. In yet other embodiments, rear view activity mirror unit may be incorporated into attaching surfaces that can be worn on the leg, for example, without limitation, pants, or a strap or band that can fit around a leg. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A rear view activity mirror for use in human activities comprising:
a mirror with a support arm;
a base to which said support arm is mounted;
a mounting mechanism that engages the support arm securely to the base; and
a bodily worn article to which the base is attached.

2. The mirror of claim 1 wherein the support arm has at least one point of flexion with reference to the mounting mechanism.

3. The mirror of claim 1 wherein the support arm has at least one point of swivel with reference to the base.

4. The mirror of claim 1 wherein the mounting mechanism comprises a ball and socket type of joint.

5. The mirror of claim 1 wherein the base comprises a track, and wherein the mounting mechanism is slidable attachment.

6. The mirror of claim 1 wherein the mounting mechanism comprises a ball in a track type of joint.

7. The mirror of claim 1 wherein the mounting mechanism comprises a clasp that slidably attaches the mirror to the track.

8. The mirror of claim 1 wherein the bodily attached article is a glove.

9. The mirror of claim 1 wherein the bodily attached article is a strap that clasps a portion of an arm.

10. A rear view activity mirror for use in human activities comprising:
a mirror;
means for joining the mirror to a supporting arm;
means for joining said joined mirror and supporting arm to a base thereby forming a rear view activity mirror structure;
means for removably joining said rear view activity mirror structure to an article worn by a person and/or directly to an article used by the person.

11. The mirror of claim 10, wherein the support arm comprises means enabling said arm to be at least partially compliant or adjustable.

12. The mirror of claim 10, wherein the bodily worn article is a glove.

13. The mirror of claim 10, wherein the bodily worn article is a strap that clasps to at least a portion of a person's arm.

14. The mirror of claim 10, wherein the bodily worn article is a shirt like article, the base being attached to a sleeve of the shirt.

15. The mirror of claim 10, wherein the mirror is specifically designed for use on one side of the body.

16. A rear view activity mirror for use in human activities comprising:
a mirror with a support arm;
a base to which said support arm is mounted;
a mounting mechanism that engages the support arm securely to the base; and
means for removably joining said base to an article worn by a person and/or directly to an article used by the person.

17. The mirror of claim 16, wherein the support arm has at least one point of flexion with reference to the mounting mechanism.

18. The mirror of claim 16, where in said mounting mechanism comprises means for joining the mirror to the supporting arm.

19. The mirror of claim 16, where in said mounting mechanism comprises means for joining said supporting arm to said base.

20. The mirror of claim 16, where in said mirror is optimally designed to be worn and used by a person using said rear view activity mirror for a certain activity(ies).
